(19) United States
(12) Patent Application Publication
(10) Pub. No.: US 2022/0025737 A1
(43) Pub. Date: Jan. 27, 2022

(54) Closing device for wells or the like

(71) Applicant: DSG S.r.l., Milano (IT)

(72) Inventor: Antonio Ghiglia, Milano (IT)

(21) Appl. No.: 17/312,040

(22) PCT Filed: Dec. 10, 2019
(86) PCT No.: PCT/IB2019/060598

§ 371 Date: Jun. 9, 2021

(30) Foreign Application Priority Data
Dec. 12, 2018 (IT) 102018000011019

(51) Int. Cl. E21B 41/00; E21B 33/02

(52) U.S. Cl. CPC E21B 41/0021; E21B 33/02

(57) ABSTRACT

A closing device for wells or the like includes a frame that is intended to be stationary in the mounted condition of the device and that delimits a through-slot; a removable closing cover, which cooperates with the frame and which can alternately be arranged in a closing or opening position of the slot, without coinciding therewith, the closing cover being provided with a locking mechanism to the frame in the closing position, the locking mechanism having a bolt that cooperates with an engagement seat integral with the frame, the locking mechanism being provided in combination with a drive tool of the locking mechanism; and enabling and disabling members of the drive tool that drive the locking mechanism or that couple the drive tool and the locking mechanism.

Object of the present invention is a closing device for wells or the like, comprising

a frame intended to be stationary in the mounted condition of the device, which frame delimits a through-slot;

a removable closing cover cooperating with said frame and which can alternatively be arranged in a closing position of said slot and in an opening position of said slot, in a position not coinciding thereto,

said cover being provided with at least one locking mechanism for locking it to the frame in the closed position and

which locking mechanism has at least two, preferably four, possibly more than four bolts each oriented with at least one directional component respectively perpendicular to one of the peripheral edges of said cover, at least two bolts being oriented towards a different perimetrical edge of the cover,

said bolts being able to be displaced from said mechanism between a retracted position with respect to said edge of the cover and a position protruding outwardly beyond said edge of the cover, engaging one stationary engagement seat provided in said frame with their end length protruding beyond said edge,

said locking mechanism being provided in combination with a drive tool of said mechanism, drive enabling and disabling members of said mechanism being provided.

Devices of this type, such as for example described in document WO2017046696, are known. A device wherein the locking mechanism has a plurality of rods with the function of bolt and which are distributed radially around a central axis of the cover is described in this document. The rods are driven by a central rotor that is guided rotatably around said central axis. The polygonal plate-shaped rotor is articulated at each angle gone to a bolt rod. The rotation of the rotor occurs thanks to a tool that couples with said rotor thanks to rotationally coupling means by means of teeth and axial seats. The enabling and disabling device for driving the locking mechanism is constituted by an element that prevents the tool from coupling with the rotor and which is fixed in a position of at least partial prohibition against the coupling of the tool by means of a coded screw.

In combination with the aforesaid configuration of the locking mechanism, an engagement seat is combined with the frame for each bolt and is provided coinciding with the displacement path of the corresponding bolt and in such a position, with respect to the corresponding bolt, that the bolt does not engage said seat in the retracted position, while in the pushed outwardly position, the bolt penetrates into the seat. The bolts are thus displaced all contemporaneously to a position radially retracted and to a position radially protruding outwardly by the rotation of the rotor. The construction of the mechanism however implies that the rods must follow a complex movement which provides a displacement in direction of their longitudinal axis and a rotation around the axis of articulation at the rotor.

Moreover, the enabling/disabling members for driving the locking mechanism are complex and provide a part that must necessarily be unmounted and removed in order to allow it to be driven. This makes it very complex and difficult to use a motorized and servocontrolled drive of the mechanism and the enabling/disabling members.

Object of the invention is to ensure high closing and locking safety of the manholes and scuttles, in general, by preventing the opening to non-authorized personnel and to personnel not in possession of specific instructions and appropriate tools. At the same time, the invention aims to provide high robustness and reliability of the device and a construction requiring limited maintenance over time that can be applied in various operative and environmental conditions.

The invention achieves the purposes specified above with a closing device for wells or the like, comprising

a frame intended to be stationary in the mounted condition of the device, which frame delimits a through-slot;

a removable closing cover cooperating with said frame and which can alternatively be arranged in a closing position of said slot and in an opening position of said slot, in a position not coinciding thereto,

said cover being provided with at least one locking mechanism for locking it to the frame in the closed position and

which locking mechanism has at least two, preferably four, possibly more than four bolts each oriented with at least one directional component respectively perpendicular to one of the peripheral edges of said cover, at least two bolts being oriented towards a different perimetrical edge of the cover,

said bolts being able to be displaced from said mechanism between a retracted position with respect to said edge of the cover and a position protruding outwardly beyond said edge of the cover, engaging one stationary engagement seat provided in said frame with their end length protruding beyond said edge,

said locking mechanism being provided in combination with a drive tool of said mechanism, drive enabling and disabling members of said mechanism being provided, and wherein

said locking mechanism comprises motion drive rotor for the displacement of the bolts,

the rotor is mounted on the cover itself and is rotatable around an axis perpendicular to the plane subtended by the cover and/or by the plane containing at least one of the motion components of the bolts,

and which rotor is integrally and rotationally coupled with a coupling joint part constituted by a coaxial projection having a non-round section cooperating with a corresponding joint part provided on the coupling end of a drive tool and constituted by a recess shaped and sized correspondingly to said projection,

while the projection and/or rotor are rotationally integral with a cylindrical cup provided on the lower side of the cover, i.e. on the side not visible in a closed condition of said slot, outside of said cylindrical cup,

at least one stationary anti-rotation locking wall of said cylindrical cup being provided, which locking wall is constituted by at least one cylindrical shell wall segment that is coaxial to the shell wall of said cup and while the shell wall of said cylindrical cup and said locking wall each have at least one hole, said holes being positioned so that to be coinciding between one another in the protruding position of said bolts,

a radial locking screw or locking pin being provided and which can be controlled manually or by a motorized drive in a position of simultaneous engagement of the two holes and in a position of disengagement from at least the hole provided in the locking wall and the head of said screw being provided with a head with a hollow whose shape constitutes a key code or the control means of the motorized drive that can be actuated on command by the enabling code.

According to a further embodiment, the device is provided in combination with both the manually driven enabling/disabling members and the servocontrolled enabling/disabling members and that can be actuated by control enabling codes.

According to an embodiment, the servocontrolled enabling/disabling members comprise:

a motorised actuator that controls an actuation travel of the screw or the locking key by means of a transmission;

a power source of said actuator;

a control unit for controlling the energy supply of the power source to said actuator, which unit comprises a communication unit adapted to receive control signals of said control unit for the interdiction or activation of the energy supply to the actuator.

According to a further characteristic, sensors for detecting the actuation travel performed are combined with the locking screw or pin and/or the actuator and/or the transmission, for example travel limit sensors in two enabling/disabling positions of the locking screw and/or pin, which are connected to the communication unit adapted to transmit said signals to a monitoring unit of the enabling/disabling status of the locking mechanism.

According to a further embodiment variant, at least one further enabling/disabling member of manual type is provided in combination with an enabling/disabling member of the servocontrolled type.

An embodiment provides that two concentric cylindrical cups are rotationally coupled to the drive rotor of the bolts, said two cylindrical cups being rotatable separately between one another and a first cup being rotationally integral with a joint part cooperating with the corresponding joint part provided on the drive tool of the locking mechanism and the second cylindrical cup of greater diameter being supported freely rotatable, while the first cylindrical cup and the second cylindrical cup are arranged one inside the other and are provided with two coaxial engagement holes of a screw or radial connection pin, which are removably engageable in said holes, and while the servocontrolled enabling/disabling members are constituted by a screw or pin that can be displaced between a position of engagement and a position of disengagement from a corresponding engagement hole provided in the second cylindrical cup.

As will be shown in more detail by the description below of an exemplary embodiment, the two cylindrical cups can be rotationally connected between one another alternately or made free to rotate independently of the other. The servocontrolled enabling/disabling members act from the outside of the second cylindrical cup instead, thus engaging therewith and locking it with respect to the rotation. Thus, it seems that when the enabling/disabling members are in a condition of disabling the drive of the locking mechanism, thanks to the screw or radial pin constraining the first cylindrical cup rotationally with the second cylindrical cup, it is impossible to actuate the locking mechanism of the cover. When the enabling/disabling members are in the condition of disengagement from the second cylindrical cup, it can rotate, thus also allowing the rotation of the first cylindrical cup and allowing the actuation of the locking mechanism of the cover.

In case of a malfunction of the enabling/disabling members, for example mechanical damage or malfunction and/or for a damage of the actuator and/or for a lack of power supply or for a malfunction of the control unit or also of the communication unit, it is possible to provide for the opening of the manhole by removing the screw or the key constraining the two cylindrical cups and thus to make the first most inner cylindrical cup free to rotate and thus free to actuate the rotor of the locking mechanism that drives the bolts.

Advantageously, also this constraining screw or pin has a head with a key-coded hollow.

Still according to a further embodiment, in combination with the characteristics set forth above, it is possible to further provide, in a different angular position with respect to that of the servocontrolled enabling/disabling members and to the screw and pin constraining the two concentric cylindrical cups, at least one further manually driven enabling/disabling member, in particular a manual enabling/disabling member of the type described previously.

According to an embodiment, said member comprises a radial locking screw or locking pin that can be manually driven, the head of said screw being provided with a head with a hollow whose shape constitutes a key code,

in combination with at least one stationary anti-rotation locking wall of said cylindrical cup, which locking wall is constituted by at least one cylindrical shell wall segment that is coaxial to the shell wall of said cup and while the shell wall of said cylindrical cup and said locking wall each have at least one hole, said holes being positioned so that to be coinciding between one another in the protruding position of said bolts,

said locking screw or said locking pin can be manually displaced to a position of simultaneous engagement of the two holes and to a position of disengagement from at least the hole provided in the locking wall.

According to an embodiment, the second cylindrical cup is also provided with a hole coinciding with the holes in the locking wall and in which the manually driven locking screw or pin engages.

Still according to an embodiment, two locking walls coaxial to one another and to the first and/or second cylindrical cup are provided, said two locking walls being provided one inside and the other outside of the shell wall of the first cylindrical cup.

When the second cylindrical cup is provided outside of the first cylindrical cup, the locking wall provided outside of the first cylindrical cup is interposed between it and the second cylindrical cup.

Thanks to the presence of further drive enabling/disabling members of the locking mechanism of the cover in combination with the aforesaid servocontrolled members and the screw or pin constraining said two concentric cups, it is possible to ensure a disabling of the actuation of the locking mechanism whenever the servocontrolled enabling/disabling members should suffer a malfunction in the condition of enabling the actuation due to which it is not possible to bring back said servocontrolled enabling/disabling members to the condition of disabling the actuation of the locking mechanism.

According to a further embodiment, which can be provided in combination with one or more of any of the preceding embodiments and variants, the rotor is constituted by a cogwheel with which a rack driving the actuation travel of a corresponding bolt meshes directly or by means of the transmission gears.

According to an embodiment, said rack is fastened at the end of the bolt most opposite with respect to the peripheral edge of the cover or formed by molding said end.

An embodiment provides that two bolts oriented towards edges opposite one another are coined with the cover, the racks combined with the bolts being provided on diametrically opposite sides of the gear.

An alternative embodiment of the invention provides a closing device for wells or the like, comprising

a frame intended to be stationary in the mounted condition of the device, which frame delimits a through-slot;

a removable closing cover cooperating with said frame and which can alternatively be arranged in a closing position of said slot and in an opening position of said slot, in a position not coinciding thereto,

said cover being provided with at least one locking mechanism for locking it to the frame in the closed position and

which locking mechanism has at least one bolt, possibly two or more locking bolts for each perimetrical, edge of said cover and which can be displaced alternatively by said mechanism between a retracted position with respect to said edge of the cover and a position protruding outwardly beyond said edge of the cover, engaging a stationary engagement seat provided in said frame with their end length protruding beyond said edge, and wherein

said bolts are constituted by levers swinging in the plane parallel to the plane subtended by the frame and/or the cover and around ages perpendicular to said plane, which wings can be displaced to an angular position in which they do not protrude beyond the perimetrical edges of the cover in a position wherein said wings protrude beyond said perimetrical edges of the cover and each engages a corresponding engagement seat integral with the frame.

According to an embodiment, said wings are each controlled independently of the other by a dedicated locking mechanism by means of a drive tool of said locking mechanism.

An embodiment variant provides that said locking mechanism is common to at least a part of said levers or all said levers, whereby by actuating it, at least said part of levers or all levers are driven simultaneously in order to assume the position not protruding from the corresponding perimetrical edge of the cover or the position of engagement in the corresponding engagement seat on the frame.

The actuation of the locking mechanism or mechanisms can occur in alternative or in combination also by means of servocontrolled means,

a motorized actuator that controls an actuation travel of the lever or levers by means of a transmission being provided;

a power source of said actuator;

a control unit for controlling the energy supply of the power source to said actuator, which unit comprises a communication unit adapted to receive control signals of said control unit for the interdiction or activation of the energy supply to the actuator.

According to a characteristic, when the drive mechanism or mechanisms are of the manually driven type, the coupling joints between the drive tool and the locking mechanism are constituted by a non-round shaped hollow whose shape encodes a key code.

Still according to a further characteristic, in combination with one or more of the variants provided for this embodiment, the locking mechanism or mechanisms are provided in combination with enabling and disabling members to enable/disable the displacement travel of said levers and/or the drive of said locking mechanism or mechanisms, which can be of the manual or servocontrolled type.

According to an embodiment, in case of enabling/disabling members of the servocontrolled type, they comprise:

a motorized actuator that controls the switching of the members in the enabling and disabling condition of the locking mechanism;

a power source of said actuator;

a control unit for controlling the energy supply of the power source to said actuator, which unit comprises a communication unit adapted to receive control signals of said control unit for the interdiction or activation of the energy supply to the actuator.

Different and multiple embodiment variants are possible for the enabling and disabling members and for the locking mechanism or mechanisms actuating the levers, These variants can be of different type and configured according to different constructive choices and can vary between purely manually driven mechanical members and purely servocontrolled members, for example by means of controls via radio or via cable or can consist in combinations of electromechanical and/or servo-assisted devices, any devices combining actuators exerting a force of electric, electromagnetic, magnetic and/or pneumatic and/or hydraulic nature being intended with them for moving mechanical devices, which mechanical devices are actuated by means of remote controls via radio or via cable or, also alternatively or in combination, servo-assisted devices wherein the control and drive action is achieved by means of manual actions and by adding to it the assistance of motorized means exerting all or part of the force needed for the actuation.

According to an embodiment, such members consist of movement looks of the drive tool and/or the locking mechanism and/or the levers along the actuation travel of the locking mechanism, in particular in the direction of the travel of the locking mechanism for release the cover from the frame, i.e. for releasing the levers from the engagement seat, which members are alternately controlled in an active locking condition of said movement and In an inactive condition of said movement lock, thanks to activation/deactivation means of the coded key type.

An alternative mod sent provides that the drive tool of the locking mechanism and said locking mechanism are respectively provided with one of two joint parts couplable and decouplable with/from one another, whereas these enabling/disabling members consist of units to prevent the coupling condition of said two joint parts, which can be activated and deactivated by command means of the coded key type.

According to an embodiment variant, the coupling of the two joint parts provided respectively on the drive tool and on the locking mechanism is of the mechanical engagement or friction type.

According to an embodiment variant, the coupling of the two joint parts provided respectively on the drive tool and on the locking mechanism is of the electromagnetic and/or magnetic type.

Still according to an embodiment variant, the actuation travel and the force necessary for moving the locking mechanism is exerted directly by the tool.

An embodiment variant can provide that the tool is dynamically connected to the locking mechanism by means of a motorized kinematic chain, thanks to which the movement of the drive tool activates a corresponding motorized transmission which is in turn connected to the locking mechanism.

An embodiment, that can be provided in any combination with one or more of the preceding variants and embodiments, has movement enabling/disabling members of the drive tool and/or the locking mechanism, or a unit to prevent the coupling condition of the two joint parts between the drive tool and the locking mechanism, which are stably residing in the locking mechanism and/or the tool or which are part in said locking mechanism.

In an alternative embodiment, such enabling/disabling members or said interdiction unit are in the form of devices separated from the frame and/or the cover or the mechanism of the closing cover.

An embodiment provides that said interdiction units are constituted by covers or shields that can be displaced between a position for interdicting the access of the drive mechanism and a position in which the locking mechanism is accessible. In this case, said covers or shields can be displaced alternately in one of said two positions thanks to motorized means.

According to an embodiment, said motorized means are controlled by a control unit activated and deactivated by means of control signals transmitted by a remote unit, for example an operative center and/or local device, such as a smart hone or the like.

In an embodiment that can be provided in any combination with the characteristics of the preceding embodiments, the levers are supported by or on the lower side of the cover.

The present invention provides further improvements which are object of the dependent claims.

An embodiment provides that the cover is formed by at least two parts or three parts arranged side by side to one another and each of which closes a part of the port delimited by the frame, at least one first of said parts being made according to one or more of the embodiments and variants described above, while said at least one second part has, on the side adjacent to a corresponding frame side, at least one projection, preferably two or more fixed projections protruding outwardly from said edge towards said frame and intended to cooperate with coinciding engagement seats provided in said side of the frame.

According to an embodiment, alternatively or in combination with said two or more fixed protections protruding outwardly from said edge towards said frame and intended to cooperate with coinciding engagement seats provided in said side of the frame, said second part has, at the two opposite sides adjacent to a facing frame length, a locking bolt cooperating with a locking seat provided in the frame, said bolt being mounted as displaceable on the lower side of said cover part and displaceable manually or by means of a motorized actuator between a position of engagement in the corresponding seat of the frame and a position of disengagement therefrom.

According to an embodiment that can be provided in combination with each of the preceding embodiments, a seat of engagement for a bolt that can be displaced in two directions to and from said second part and which is made according to one or more of the characteristics and variants described above is provided on the side of said second cover part adjacent to said first part, i.e. the side next to it.

An embodiment variant provides that said first part closes a central zone of the opening defined by the frame, a second part of the cover being provided on each of the two opposite sides of said first central part, which second parts are made symmetrically identical to one another with respect to said central part of the cover.

Still according to a further characteristic that can be provided in combination with the preceding embodiments, with the exception of the one providing a cover formed by two or more parts, the locking mechanism of the cover has a single bolt intended to engage a seat of a side of the frame combined with an edge of said cover, whereas, on the opposite side of the cover, at least one fixed projection is provided, preferably a couple of fixed projections arranged at a distance from one another along said opposite side and which cooperate with coinciding seats in the corresponding side of the frame.

An advantageous embodiment of said projections fixed on the second cover parts or on the cover according to the last variant described provides that said projections are in the form of circular or annular sectors having an angular extension of less than 360° and an opening on their side facing the side of the frame in which the coinciding engagement seats are provided.

A further embodiment that can be provided alternatively or in combination with any of the preceding one or more embodiments or variants concerns a closing device for wells or the like, comprising

a frame intended to be stationary in the mounted condition of the device, which frame delimits a through-slot;

a removable closing cover cooperating with said frame and which can alternatively be arranged in a closing position of said slot and in an opening position of said slot, in a position not coinciding thereto,

said cover being provided with at least one locking mechanism for locking it to the frame in the closed position and

which locking mechanism has at least two, preferably four, possibly more than four bolts each oriented with at least one directional component respectively perpendicular to one of the peripheral edges of said cover, at least two bolts being oriented towards a different perimetrical edge of the cover,

said bolts being able to be displaced from said mechanism between a retracted position with respect to said edge of the cover and a position protruding outwardly beyond said edge of the cover, engaging one stationary engagement seat provided in said frame with their end length protruding beyond said edge,

said locking mechanism being provided in combination with a drive tool of said mechanism, drive enabling and disabling members of said mechanism being provided,

said mechanism being mounted on a frame separated from the cover and removably fixable to the stationary frame delimiting the passage opening, said supporting frame of the mechanism being provided with at least two hooking appendages each on one of two opposite sides of said frame, which hooking appendages are hooked to hooking seats carried by the stationary frame, on the inner side thereof, and

the cover being also provided with at least two removable coupling appendages for coupling to said supporting frame and which cooperate with the engagement seats provided on the supporting frame itself when the supporting frame and the cover are in a coupled position between one another and the frame of the manhole,

while the hooking appendages of the supporting frame of the mechanism and the coupling appendages of the cover are provided with engagement seats that, in a coupled position between one another and the stationary frame of the manhole, position themselves in a position coinciding with the path of a corresponding bolt and while, in the position of the bolts displaced outwardly towards the stationary frame, at least two bolts simultaneously engage a corresponding hooking seat combined with the stationary frame of the manhole, a corresponding engagement seat provided in the hooking appendages of the supporting frame and a corresponding engagement seat provided in the coupling appendages of the cover to the supporting frame, locking the cover to the supporting frame and the supporting frame of the mechanism to the stationary frame of the manhole and

while, in a retracted condition of the bolts, these no longer engage said seats and the cover can be freely separated from the supporting frame of the mechanism and the supporting frame of the mechanism can be freely separated from the stationary frame of the manhole.

Thanks to this characteristic, the part of the cover only has the closing function, while the weight of the mechanism is supported by a dedicated supporting frame. This way, the locking of the cover in the closing condition is ensured and simultaneously, the cover can have a structure only intended for the closing function of the opening. Moreover, with respect to the embodiment that uses the cover as a supporting frame of the mechanism, the two parts that must be raised and displaced are less heavy and the operation of positioning the opening in the closing or moving away position is considerably facilitated.

An embodiment provides that the supporting frame of the locking mechanism is constituted by at least one crosspiece having a length substantially corresponding to the distance of two opposite sides of the stationary frame of the manhole and that, on each of its ends, has a wing perpendicular to the longitudinal extent of the crosspiece and/or to the travel direction of the bolts and parallel to a plane oriented in direction of the axis of the opening delimited by said stationary frame and/or optionally to the side thereof combined with the corresponding end of the crosspiece, while the stationary frame has, in a position aligned with each of said two opposite wings, a support element of the corresponding end of the crosspiece, which support element is fixed on the side of each side element of the frame of the manhole combined with an end of said crosspiece and which has or delimits a hooking slit of the corresponding hooking wing, each hooking wing having a length so that, when the supporting frame of the looking mechanism is in the hooked condition to the stationary frame of the manhole, an end length thereof protrudes beyond the lower end of the corresponding slit and in said protruding end length each hooking wing has an engagement opening that is directly adjacent to the lower end of the slot and that is coinciding with the displacement path of the corresponding bolt and while, in a position of the bolt pushed towards the frame of the manhole, the bolt passes through said opening and positions itself directly under the lower end of the slit, superimposing itself to the lower edge of the support element delimiting the slit itself and while, in the retracted condition of the bolts, each bolt is fully extracted from the opening provided in the corresponding hooking wing of the supporting frame of the locking mechanism.

According to a further characteristic, the cover has at least two coupling appendages for coupling to the supporting frame of the mechanism, i.e. to said crosspiece, which appendages have the shape of wings oriented similarly to the hooking wings of the supporting frame and protruding from the lower side of the cover towards the supporting frame of the locking mechanism, i.e. towards the crosspiece and which coupling wings are provided in a position coinciding with the engagement loops provided in the crosspiece forming the supporting frame, and said coupling wings have a length so that, in a coupled position of the cover to the supporting frame, the wings protrude from the lower side of the supporting frame, i.e. from the side opposite the cover of said frame, with an end length, in said end length each coupling wing having an engagement slot of the corresponding bolt, to which slot is coinciding and aligned with the travel of said bolt with the engagement opening in the corresponding hooking wing of the supporting frame to the frame of the manhole.

As will be clearer in the following detailed description, in the condition of locking the cover of the manhole to the stationary frame, at least one couple of opposite bolts simultaneously engages the two openings of the hooking wings and the coupling wings, thus simultaneously locking the supporting frame of the locking mechanism to the stationary frame of the manhole and the cover to said supporting frame, In a retracted condition of the bolts, the hooking wings of the supporting frame of the locking mechanism and the coupling wings of the cover are free and the cover and the supporting frame of the locking mechanism, with the looking mechanism itself, can be removed from the stationary frame of the manhole, thus freeing the access to the compartment whose opening is delimited by the manhole.

An embodiment variant provides that the support elements have a wall parallel to the corresponding hooking wing, an opening for the passage of the corresponding bolt, which is positioned coincidently with the engagement opening of said bolt and provided on the hooking wing of the supporting frame, being provided in said wall. In this case, when the bolt is pushed outwardly in the locking position, said bolt passes through the engagement opening in the hooking wing of the supporting frame of the locking mechanism and in the opening provided in the wall of the support element.

In a position of the supporting frame of the locking mechanism mounted to the stationary frame of the manhole, said supporting frame leans on the upper edge of the support elements.

An embodiment provides four bolts arranged cross-like between one another, while also the supporting frame is obtained with a cross-like plan shape correspondingly to the orientations of the displacement paths of the bolts, each branch of the supporting frame of the locking mechanism being provided at its free end with a hooking wing cooperating with a corresponding hooking seat or slit on the frame of the manhole and the cover being optionally provided with a coupling wing positioned coinciding with a corresponding branch of the supporting frame and Intended to engage in a coupling slot provided in said branch.

The embodiment variant that provides the supporting frame for the locking mechanism and the cover as separate and independent constructive parts can clearly be provided in combination with one or more of any of the embodiments and variants described above, said forms being easily modifiable and adaptable by the technician of the art in the context of his basic abilities.

In particular, the combination of this embodiment with the embodiment that provides to divide the cover into at least two parts or three or more parts is also clear, the locking mechanism being mounted on one of said parts and the hooking seats of the supporting frame of the mechanism being at least on the sides of the fixed frame which are directly adjacent to said supporting frame and/or also on the sides of the cover part or parts that axe not couplable to the frame of the locking mechanism and that are directly adjacent to this cover part.

These and other characteristics and advantages of the present invention will be more evident from the following description of same exemplary embodiments depicted in the attached drawings wherein:

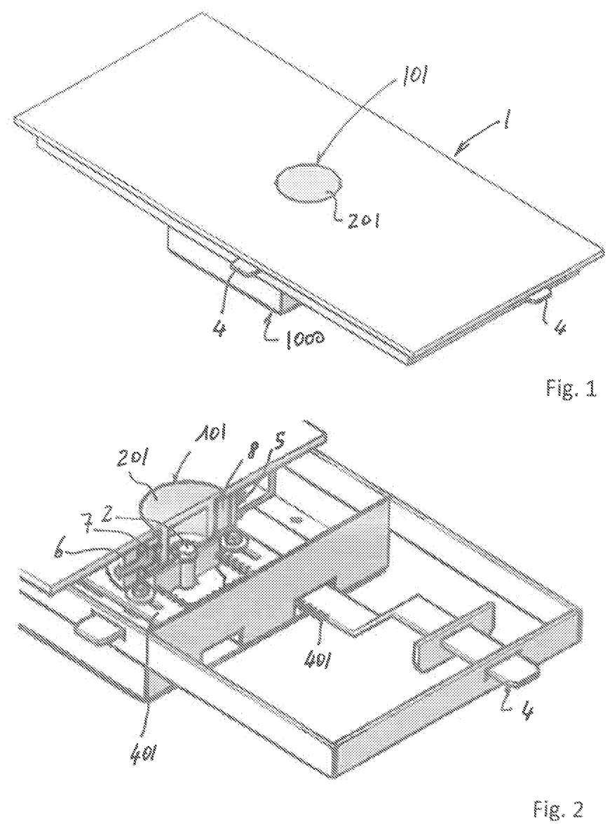

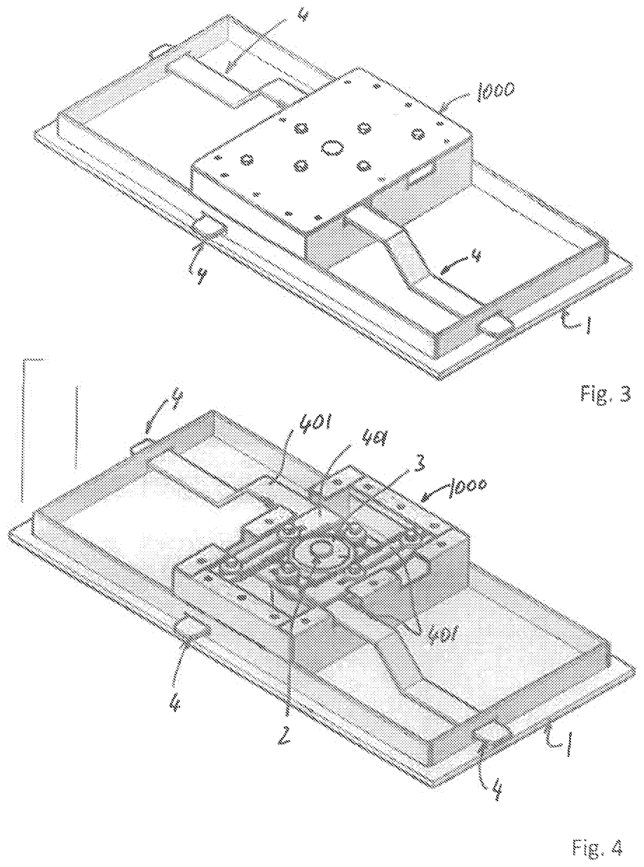

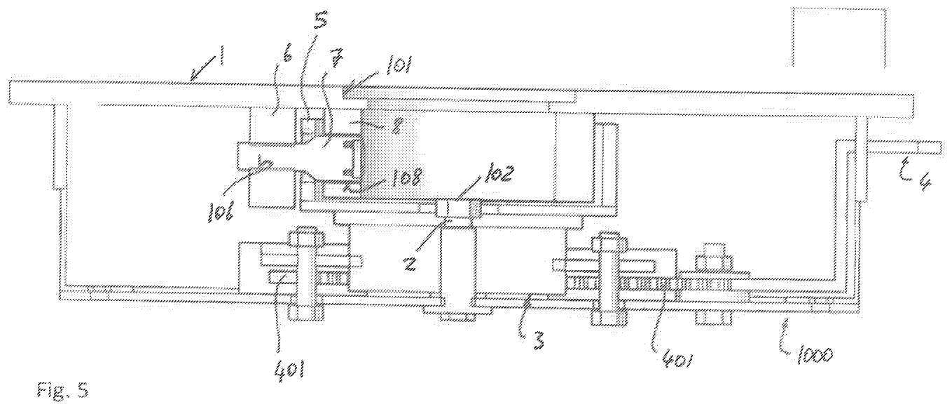

FIGS. 1 to 5 show different views of a first embodiment of the device according to the present invention, provided with a locking mechanism comprising a cogwheel borne rotatably on the lower side of the cover around an axis perpendicular to the faces of the cover and which slidingly actuates two bolts that can be displaced in directions opposite one another thanks to a rack combined with each bolt, while the members enabling/disabling the drive of the locking mechanism are of manual type.

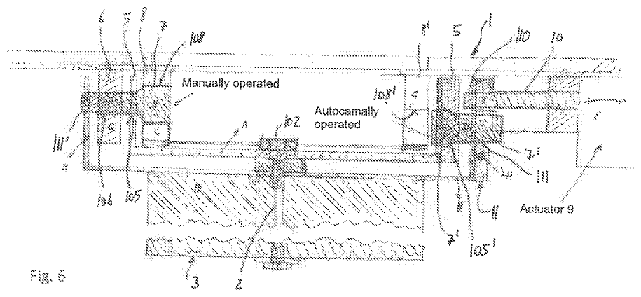

FIG. 6 shows an embodiment variant wherein motorized enabling/disabling members controlled by a control unit by transmitting control signals are provided in combination with manual enabling/disabling members of the type according to the embodiment of FIGS. 1 to 5.

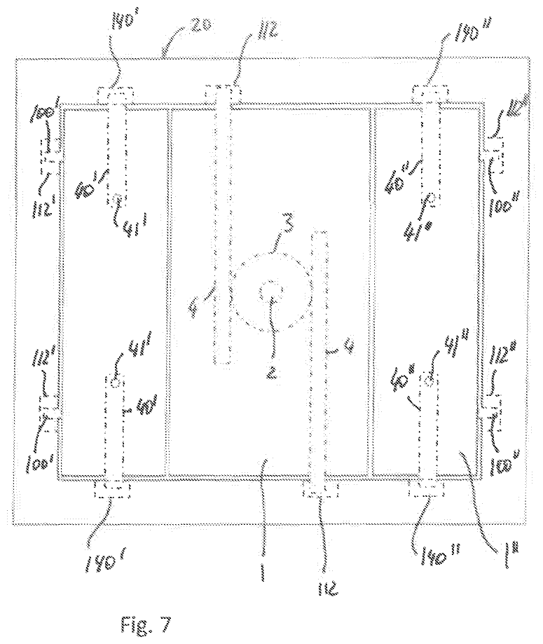

FIG. 7 shows an embodiment variant of the embodiment according to FIGS. 1 to 5 or FIG. 6.

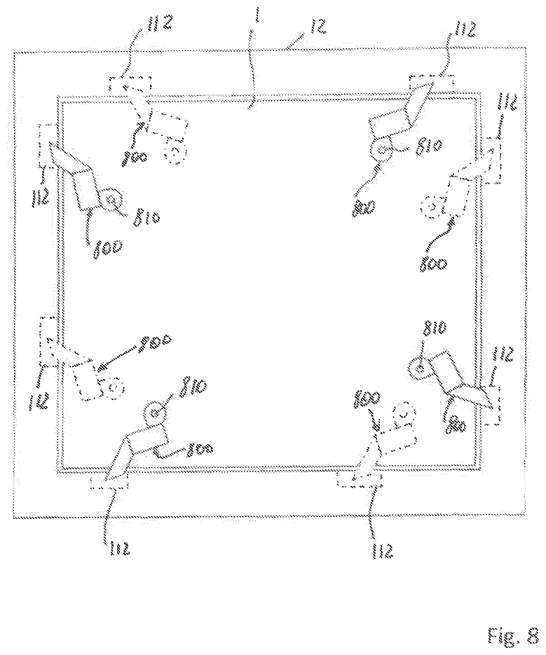

FIG. 8 shows a third embodiment.

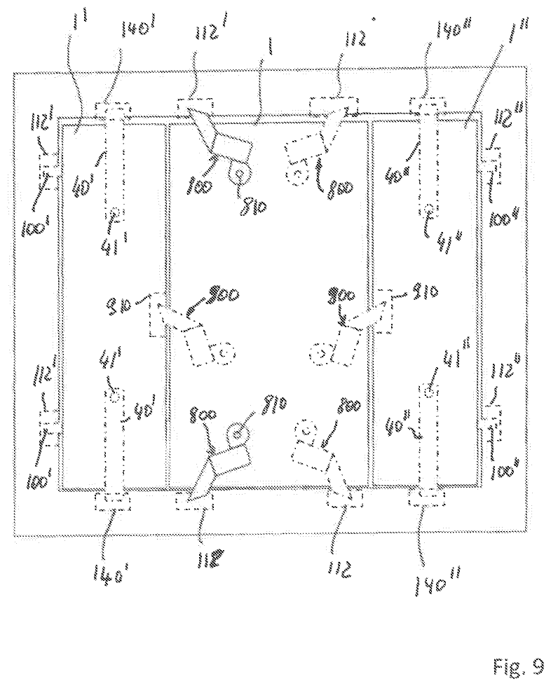

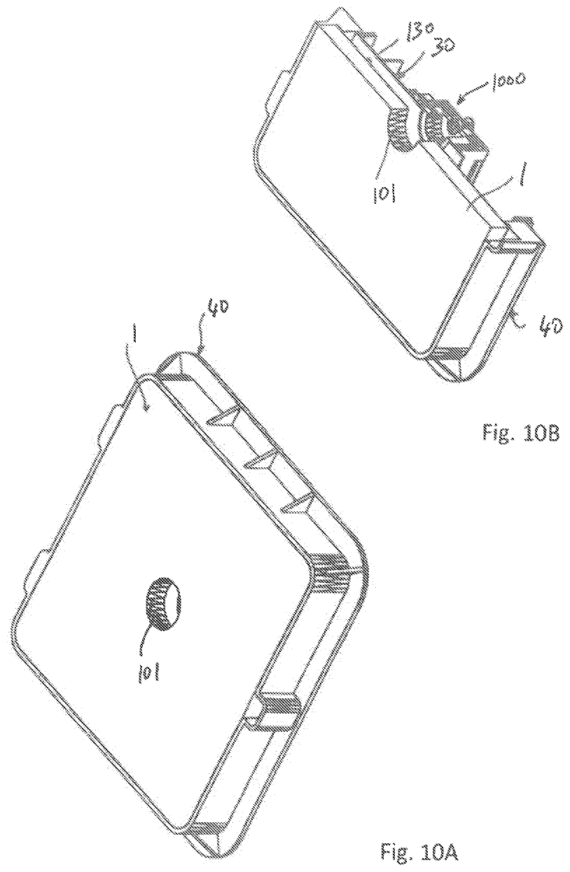

FIG. 9 shows an embodiment variant of the embodiment according to FIG. 8.

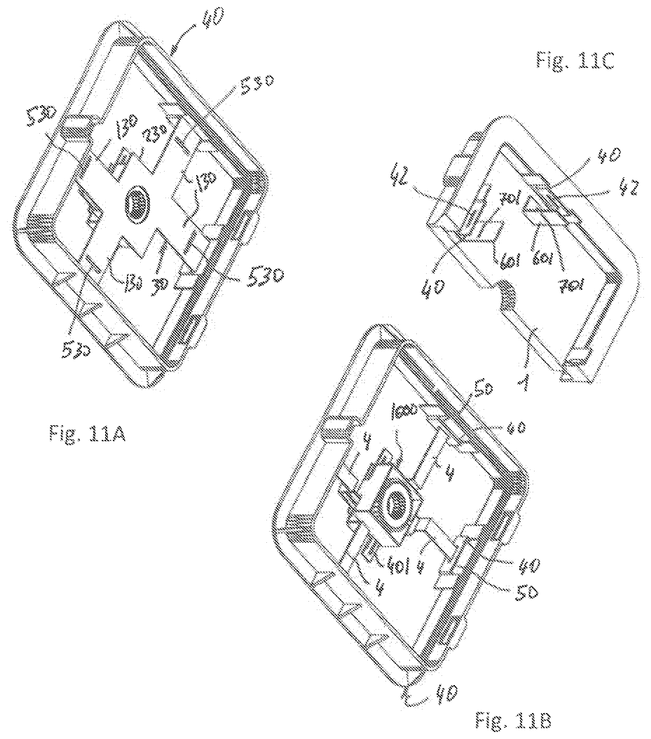

FIGS. 10A to 11C show different views of the manhole according to a further embodiment variant wherein the locking mechanism is not borne by the cover, but is mounted on a separate supporting frame and constitutes an independent and separate part with respect to the cover itself, reciprocal engagement members being provided between the cover and the supporting frame of the locking mechanism and between this supporting frame and the stationary frame of the manhole which can be activated and deactivated by the locking bolts.

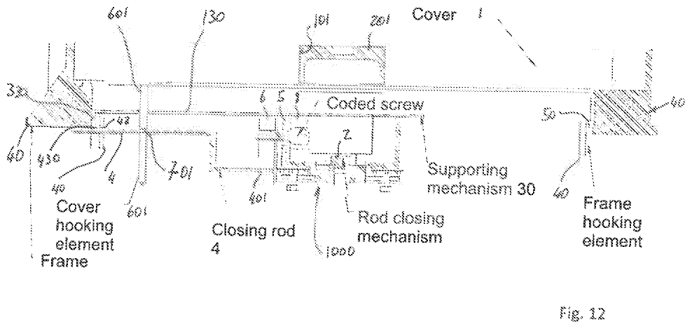

FIG. 12 shows the locking condition of the cover of the manhole to the stationary frame thereof, with reference to the embodiment of FIGS. 10A to 11C.

With reference to FIGS. 1 to 5, different views of a first embodiment of the present invention are shown therein. The figures only show the cover, the frame being omitted. This is made for example as a continuous frame delimiting an opening identical in shape and sites to that of the cover.

The cover has a closing plate 1 with a slot in the central zone denoted by 101 that can be closed by means of a small cover 201.

Said slot allows the access to a coupling part, in this case a hexagonal head 102 of a rotatingly supporting shaft 2 of a coaxial gear 3. The gear 3 engages, on sides diametrically opposite one another, a rack 401 provided at the end of a rod 4 constituting a removable locking bolt of the cover to the frame (not shown). In this case, the two rods are oriented perpendicularly to a respective peripheral edge 301 of the cover 1 of two opposite peripheral edges. The rods 4 with the racks 401 extend tangent to said gear 3 and are displaced in direction of their longitudinal axis, in the two directions thanks to the gear 3 between a retracted position with respect to the edge of the cover 1 and an outwardly protruding position with respect thereto, in which they engage with their protruding ends an engagement seat provided in a point of the frame coinciding with the displacement trajectory of the corresponding rod 4.

The non-round head 102 of the shaft 2 which is in the form of threaded bolt or pin is mounted coaxial with respect to a cylindrical cup 5 which is integral in the rotation with the gear 3. The cylindrical cup 5 is oriented with its upper base side open towards the plate of the cover and is coinciding with the slot 101, thus forming an access chamber to the non-round head 102 of the shaft 2 thanks to which it is possible to rotationally engage, with said head, a drive tool of the gear 3 and of the cylindrical cup 5 rotationally integral therewith.

The cylindrical cup 5 is free to rotate integrally with the gear 3 and the cylindrical shell wall is flanked at least on one side by at least one stationary wall segment 6, in the form of a wing or cylindrical wall region coaxial with the shell wall of the cylindrical cup 5, which is provided with an engagement hole 106 for a pin or radial screw 7 constituting an enabling/disabling member of the rotation of the cylindrical cup 5 and thus of the gear 3. The cylindrical cup 5 has, along an annular trajectory coinciding with the hole 106 on the wall segment 6, a hole 105 also intended to engage the enabling/disabling pin or screw 7.

The wall segment is positioned in such an angular position with respect to the rotation axis of the cylindrical 5 that, when the hole 106 thereon and that on the shell wall of the cylindrical cup are coinciding with one another, the rods 4 are in the position protruding outwardly from the corresponding edge and engaged in the engagement seats provided on the frame.

The embodiment shown provides two segment walls arranged side by side one another, one 6 outwardly protruding from the cylindrical cup 5 and the other 8 inwardly therefrom, both being provided with an engagement hole respectively 106, 108 of the screw 7 and said holes being provided in a position coinciding with one another.

The wall segments 6 and 8 are integral with the plate of the cover 1 and protrude cantileverly from the side thereof facing the gear 3 and the cylindrical cup 4.

One or both the walls 6 and/or 8 can be in complete cylindrical shape, such as for example how the wall 8 is made in the present example.

In the present example, the screw or radial key 7 has a threaded engagement end intended to screw in the hole 106 of the wall segment 6 obtained internally threaded correspondingly, while the head simultaneously engages the holes 105 of the cylindrical cup 5 and 108 of the stationary inner cylindrical wall 8.

The displacement of the screw 7 or the pin to the position shown, in which they engage all three holes 106, 105 and 108 and to the position in which said screw or pin was removed, thus freeing the rotation of the cylindrical cup 5, can be actuated manually or it is possible to provide a motorized actuator that controls the displacement of the pin in the direction of its axis and of that of the holes concentric to one another.

In the first case, the head of the screw or pin has a coded key-like recess, so it can only be actuated thanks to a key coupling to said screw or pin 7 and appropriately shaped according to the code provided.

In case of a displacement by means of an actuator, it is advantageous for the size of the inner zone of the cylindrical cup 5 to provide that the screw or radial pin are inserted into said holes 106, 105, 108 with a radial travel from the outside towards the inside and extracted to enable the actuation of the gear 3 with a travel from the inside towards the outside, while the actuator is provided on the outer side of the radially most outer wall segment 6.

In case of an actuation by means of a motorized actuator, a power source of said actuator and a control unit managing the supply of energy to the actuator, which control unit has a communication unit communicating with a control interface, are combined with the cover.

The control interface can be provided directly on the cover or can be constituted by a remote device connected to the control units by means of wireless connection or by means of wired connection. Through this control interface, it is possible to transmit, together with a univocal identification and control enabling code, the actuation controls of the actuator for enabling or disabling the actuation maneuver of the locking mechanism of the cover, i.e. of the gear 3 by actuating the shaft 2 by means of the drive tool.

According to a further characteristic, a state sensor that detects the switching condition of the enabling/disabling member and which allows to check the state conditions by comparing them with the control sent to detect the conditions of non-operability of the actuator can be further combined with the enabling/disabling device. In this case, the communication unit combined with the control unit on the cover and the control interface are provided respectively with a transmitting section and a receiving section that allows the control interface to receive and visualize the state signals detected by the sensor or sensors.

An improved embodiment allows not to lose the operability of the locking mechanism for the locking or releasing of the cover from the frame, also in case of a malfunction of the motorized system for actuating the drive enabling/disabling members of the gear of the locking mechanism of the cover.

An example of this embodiment is shown in FIG. 6. In this case, a cover of a manhole with an electronic lock comprising the cylindrical cup 5 free to rotate together with the shaft 2 with the non-round head 102 and the gear 3 is shown. A safety collar fastened to the manhole and obtained similarly to the cylindrical wall 8 of the present example is provided with a first and a second hole with radial axes denoted by 108, 108′, which holes are arranged diametrically opposite one another.

A key-coded coupling head screw, for example coded and denoted by 7, 7′, is intended respectively to cooperate with a respective hole 108, 108′. An actuation actuator 9 controlling the displacement travel of a worm screw 10 with an end forming a radial pin 110 of engagement of a hole 111 provided in a cylindrical cup 11 of a diameter greater than the cylindrical cup 5 rotationally integral with the gear 3 and which is free to rotate with respect to the remaining parts of the device and in particular to the gear 3 and to the cylindrical cup 5 as well as to the shaft 2.

The cylindrical wall 8 is provided inside the cylindrical cup 5 similarly to the previous example, while the wall segment 6 is provided outside of the cylindrical cup 5 similarly to the previous example, but interposed between the shell wall thereof and the cylindrical one of the most outer cylindrical cup 11.

9 denotes not only the actuator for actuating the worm screw, for example an electric motor, but also the control logic and power.

In this case, similarly to the example of the motorised enabling/disabling members described with reference to the variant of the previous example, the control logic can provide a power source of said actuator and a control unit managing the supply of energy to the actuator, which control unit has a communication unit communicating with a control interface.

The control interface can be provided directly on the cover or can be constituted by a remote device connected to the control units by means of wireless connection or by means of wired connection. Through this control interface, it is possible to transmit, together with a univocal identification and control enabling code, the actuation controls of the actuator for enabling or disabling the actuation maneuver of the locking mechanism of the cover, i.e. of the gear 3 by actuating the shaft 2 by means of the drive tool.

According to a further characteristic, a state sensor that detects the switching condition of the enabling/disabling member and which allows to check the state conditions by comparing them with the control sent to detect the conditions of non-operability of the actuator can be further combined with the enabling/disabling device according to this embodiment. In this case, the communication unit combined with the control unit on the cover and the control interface are provided respectively with a transmitting section and a receiving section that allows the control interface to receive and visualize the state signals detected by the sensor or sensors.

With reference to the construction of FIG. 6, in the left part thereof, aside the presence of the most outer cylindrical cup 11, the implementation of the parts denoted by 5, 6, 7 and 8 is correspondent to the one with the manually driven enabling/disabling members described in the example of FIGS. 1 to 5.

The screw or pin 7′ can also be provided with a key-like coded coupling head and its function is that of being able to rotationally constrain the most inner cylindrical cup 5 rotationally integral with the gear 3 with the most outer cylindrical cup 11 that can be locked with respect to its rotation by the radial pin 110 at the end of the worm screw 10, while the hole 108′ in the most inner cylindrical wall 8 borne by the plate of the cover 1 has the only function of passing said screw 7′ and of accessing the head thereof.

The device according to the variant of figure 6 allows two alternative operating modes: one automatic and one manual.

The stationary wall segment 6 allows the coded screw 7 to lock the closing, when the cover is in manual mode. The cylindrical cup 11 is free to rotate and can be locked by the pin 110 controlled by the actuator 9.

With reference to the mechanical functionality, the enabling/disabling of the actuation of the locking mechanism and in particular the actuation of the gear 3 through the non-round head 102 of the shaft 2 provides that the coded screw 7 locks the cylindrical cup 5 and the cylindrical cup 11 by engaging in the holes 106 of the wall segment 6 and in the hole 108 of the cylindrical wall 8. In this mode, even if the key 110 on the worm screw 10 should be locked in the engagement position of the cylindrical cup 11 and thus rotationally locking it, by unscrewing the screw 7 until removing it and similarly the screw 7′, the cylindrical cup 5 connected to the gear 3 would be released both by the stationary wall segments 6 and 8 and by the cylindrical cup 11, thus allowing its rotation and thus the actuation of the gear 3 for the displacement of the rods 4 to the opening and/or closing position.

By assuming a malfunction of the actuation system 9, with the pin in the position of disengagement from the shell wall of the cylindrical cup 11 (position not shown but consisting in the displacement of the screw 10 and the pin 110 towards the right of FIG. 6 in a position spaced from the cylindrical wall of the cup 11), it is possible to also ensure the secure closing of the manhole by securely locking the locking mechanism in the condition in which the cover is constrained to the frame by inserting the screw 7 in the position in which it engages at least the holes 108, 105 and 106 and possibly a hole 111′ in the shell wall of the cylindrical cup 11.

For the only servocontrolled or motorized mode, it is possible to provide an intermediate configuration in which the key coded screw 7 is missing or all the constructive parts cooperating with said screw 7 and being part of the solution according to FIGS. 1 to 5 provided in the left part of FIG. 6 are missing and in which the coded screw 7′ must be screwed in the seats denoted by 105′ and 111′ shown in the right part of FIG. 6, by accessing said seats through the hole 108′ in the wall 8. In this configuration, the cylindrical cup 5 rotationally integral with the gear 3 is rotatably constrained with the cylindrical cup 11. The enabling/disabling of the rotationally actuation of the gear 3 through the combined rotation of the two concentric cylindrical cup rotationally integral through the screw 7′ thus only occurs thanks to the displacement of the pin 110 to the position for locking or freeing the rotation of the cylindrical cup 11.

The invention also provides a control logic of the actuation system 9. This comprises a control unit that controls the actuator actuating the worm screw. The electronics and the actuator are supplied by a battery possibly placed in the well closed by the device and/or in a housing obtained in the cover.

According to an operative mode, the control unit of each device can be connected 24/7 to an Intranet network, thus being able to be connected to a centralized system that manages its openings and closings according to the following modes:
Upon request
Timed

According to an embodiment, the enabling of the actuation of the locking mechanism of the cover of a device for unlocking the cover from the frame can occur according to the following procedure:

1. The operative station enables the time frames in which the operator can unlock the cover from the device;

2. The operator who went on site, by means of an App installed on a portable control device, such as a smartphone or the like, can proceed to the opening/closing of the manhole.

Moreover, the system allows security profiling that allows to manage the enabling according to groups and subgroups, whereby only the authorized operators, present on site during the unlocking time frame, can proceed with the drive enabling operation of the locking mechanism in the sense of a release of the cover from the frame.

All the opening/closing operations of the manhole are stored on a log that records the operator, opening/closing times and reason.

FIG. 7 shows a possible embodiment variant of the device described according to the preceding figures and which is particularly advantageous for covers of great sizes and thus of considerable weight if made in one piece.

In this case, the cover is formed by three parts. The example is not to be understood as limiting, but it is also possible to provide only two parts or more than three parts of which one is made according to one or more of the preceding embodiments or variants thereof and the other parts are made according to the description below.

With reference to the embodiments shown and described, the rotationally actuation of the gear 3 is provided by using a tool that engages the non-round head 102 of the shaft 2.

This tool can be of the manually driven type or a motorized tool for which the rotation is imparted by a motor, for example an electric motor on whose axis a rotationally coupling terminal is coaxially fitted on the head 102 of the shaft 2.

Still according to a further variant which can be provided in combination with any of the preceding variants, the locking mechanism can also be of the motorized type, an actuation system obtained similarly to the actuation system described for the enabling/disabling members as far as the most general characteristics of the actuation system are concerned, being provided mounted on the cover. Among the different variants, it is possible to provide an actuation system with actuators of the hydraulic, oleodynamic or pneumatic type, the rotation of the gear being controlled by the stem of an actuating cylinder, while the drive tool controls the valve or valves or the pump or pumps supplying the pressurized fluid to said cylinders to perform the desired path.

Alternatively, the actuating cylinder can be constituted by a linear mechanical cylinder driven by an electric rotary or linear motor or it is possible to provide electric motors that engage the gear 3 with a pinion for transmitting the motion of the shaft of said motors.

The control electronics can be obtained similarly to that which is provided for the enabling/disabling members and, in this case, according to an embodiment variant, said members can be constituted by an electronic system operating by means of password for enabling the control of said motors.

FIG. 7 shows a further variant that can be applied to the preceding embodiments.

In the schematic example of FIG. 7, equal parts or with functions equal to that which is described in the preceding embodiments are denoted by identical reference numbers.

In particular, the cover is formed by three parts, a central part 1 and two side parts 1′, 1″ which are arranged side by side at the central part on opposite sides thereof.

This has the advantage of limiting the weights of the cover within the values provided by the standards on the safety of personnel when the extent of the cover is of great sizes.

As is clear, the central part 1 is made according to one or more of the embodiments described previously with only one couple of bolts that are engaged in the seats 112 provided in the frame 12.

Each of the cover parts 1′ 1″ is in turn engaged to the frame 12 along the side opposite the one interfacing with the central wall 1 of the cover. This occurs thanks to at least one peripheral projection 100′, 100″, preferably a couple of said peripheral projections provided on the corresponding side part 1′, 1″ of the cover and which are fixed on said part of the cover and engaged in coinciding seats 112′, 112″ of the corresponding side of the frame 12.

As is clear, the locking mechanism and the parts combined therewith provided on the central part can be obtained according to one or more of any of the embodiments and variants described previously.

With reference to a further improvement which can be provided or not in combination with the preceding characteristics and which is present in the embodiment of FIG. 11, each side part 1′, 1″ of the cover can provide a bolt 40′, 40″ mounted on the lower side thereof at the two opposite sides perpendicular to the edge provided with fixed projections 100′, 100″ and which are intended to be engaged in an extractable way inside coinciding seats 140′, 140″ provided integral at the side of the frame perpendicular to the one with which the fixed projections 100′, 100″ are engaged.

According to a preferred embodiment, these bolts are translatable in parallel to themselves in direction of their longitudinal axis in two ways to and from the corresponding seats 140′, 140″ and are oriented with this longitudinal axis or with at least one directional component of said axis perpendicularly to the side of the frame 1 in which the seat 140′, 140″ is provided as combined.

Advantageously, said bolts can be manually driven thanks to gripping terminals 41′, 41″ and are mounted on the side of the cover parts 1′, 1″ facing the port delimited by the frame. Said bolts 40′, 40″ not being accessible from the outside and constituting a further fastening constraint for fastening the side parts 1′, 1″ of the cover to the frame in a mounted condition of all parts 1, 1′, 1″ of the frame. This arrangement ensures greater resistance of the modular or sectional cover according to FIG. 11 and the respective variants in raising attempts by means of lock-picking tools.

FIG. 8 shows a further embodiment of the device according to the present invention.

In this case, the bolts are constituted by swinging levers 800 swinging around axes 810 perpendicular to the faces of the cover 1 or to a plane subtended by the frame 12.

The levers 800 each cooperate with an engagement seat 112 provided in the frame 12 and said levers are provided at least in the number of two levers, preferably respectively on two opposite edges of the cover 1.

As depicted in the example, a preferred solution provides at least one lever 800 for each side of the cover.

Instead, as depicted by the dotted lines, it is possible to provide a plurality of levers in greater number distributed along the perimeter of the cover.

As far as the actuation of the angular travel of said levers 800 is concerned, it is possible to provide a manual or motorized actuation system independently for each lever or anyhow for at least one subgroup of said levers or common for all levers, a drive member being mechanically connectable with each lever or with a subgroup of said levers or with all levers by means of a transmission which can be mechanical or of the electric or electronic type.

The actuation system can be made according to one or more of the variants described above and it is possible to also provide enabling/disabling members for the angular actuation of said levers according to one or more of the preceding variants.

Similarly to the embodiments described previously, the technician of the art can adapt them, mutatis mutandis, to the present embodiment.

In general, the enabling/disabling members can be both of the mechanical or servocontrolled type or of a purely electronic type, thus allowing the transmission or receipt of actuation controls to the actuators only in the presence of a predetermined enabling or authorization code.

FIG. 9 shows, similarly to FIG. 7, the embodiment variant of the embodiment of FIG. 8 to a solution in which the cover is constituted by at least two or more parts, equal parts or identical functions being denoted by the same reference numbers of FIG. 7. Moreover, in this case, the levers 900 engaging the seats 910 provided at the edges of the parts 1′, 1″ adjacent to the edges of the central cover part 1 are denoted by dotted lines.

With reference to FIGS. 10A, 10B, 11A, 11B, 11C e 12, a further embodiment that can be provided in combination with one or more of the characteristics of the embodiments and/or variants described with reference to FIGS. 1 to 7 is shown therein.

In the following description, identical reference numbers will be used for identical parts or with the same functions.

FIG. 10A shows the manhole in a closed condition with the cover 1 mounted on the frame 20. In the center of the cover 1, there is a compartment for accessing the drive tool of the locking mechanism that is shown in an open condition, the small cover 201 being omitted.

FIG. 10B shows a section according to a central plane perpendicular to the face of the cover 1, a part of the locking mechanism that will not be described in detail is visible, said mechanism being able to be obtained according to one or more of the embodiments and/or variants described with reference to FIGS. 1 to 7 or to any other type of mechanism that moves the bolts 4 such as to perform locking/unlocking travels like those that will be described in more detail below. The locking mechanism assembly is denoted by 1000 in FIGS. 10A to 12.

FIG. 10B shows a crosspiece 130 of a further frame 30 that is made separated from the cover 1 and to which the locking mechanism 1000 is fastened.

In particular, as shown in FIG. 10B, the crosspiece 130 has, at its ends, hooking wings cooperating with seats provided of the side element of the stationary frame 20 against which a corresponding end of the crosspiece 130 abuts.

FIGS. 11A, 11B, 11C show in more detail the construction of the supporting frame 30 of the locking mechanism 1000.

The frame 30 is substantially cross-like made and has a central part 230 supporting the coupling means of the locking mechanism 1000 for coupling to the tool, from which central part four crosspieces cross-like arranged to one another branch off, said crosspieces being arranged with their longitudinal axes staggered with respect to the axis passing through the center of rotation of the locking mechanism. Each crosspiece ends against a side of the stationary frame 20 of the manhole and has, at its end adjacent to said side element of the manhole, a wing oriented in parallel to the axis of the opening defined by the stationary frame 20 of the manhole, i.e. perpendicular to the face of the cover 1.

Each wing engages a hooking slit 40 delimited by a bearing element for bearing the ends of the crosspieces, denoted by 41.

This bearing element delimits, towards the inside of the stationary frame 20, the slit and has an opening 42, in the wall parallel to the side element of the stationary frame 20 and to the hooking wing 330 of the corresponding branch 130 of the supporting frame 30, that is placed coinciding with the corresponding bolt 4 and has a shape such as that, in the travel limit position pushed outwardly of the bolt 4, the latter is inserted into the opening 42. Each hooking wing 330 at the end of the corresponding crosspiece 130 of the supporting frame 30 has an opening 430 that, in a hooked condition thereof at the corresponding slit 50 delimited by the bearing element 40, it places itself coinciding with the opening 42 in the wall of the bearing element 40 itself. Thus, when the corresponding bolt is pushed outwardly, it passes through the coinciding openings 42 and 430 respectively of the bearing element 40 and the hooking wing 330, thus locking the supporting frame 30 to the wall of the manhole.

It is clear how an alternative embodiment can simply provide, instead of the opening 42 in the wall of the bearing element 40, that the corresponding hooking wing 330 has a greater length than the wall of the bearing element 40 in the direction of its inserting in the seat, i.e. in the slit 50 delimited by said bearing element, while the opening 430 on the hooking wing is provided directly adjacent to the lower edge of the wall of said hooking element 40, thus, in a condition pushed outwardly of the corresponding bolt, it places itself in the opening 430 and under the lower edge of the bearing element, thereby equally preventing the moving away of the supporting frame 30 from the stationary frame 20 of the manhole.

As shown in the figures and in particular in FIGS. 11A and 11C, the crosspieces 130 have, in an Intermediate point, an opening 530, while the cover 1 has a coupling wing 601 protruding from the lower side for each crosspiece 130 of the supporting frame 30. Alternatively, it is also possible to provide a smaller number of coupling wings 601, but preferably such number must be at least constituted by two coupling wings 601 each cooperating with a different crosspiece 130 or a gone of two zones substantially diametrically opposite one another.

The openings 530 in the supporting frame 30, in particular in the crosspieces 130, are coinciding with the coupling wings 601 in the closed position of the manhole and in this position, the coupling wings pass through the corresponding opening 530 protruding beyond the supporting frame 30 on the lower side thereof and having an engagement opening 701 in a position coinciding with the path of the corresponding bolt 4.

The position of the openings 530 on the supporting frame 30 and consequently of the coupling wings 601 on the cover 1 is selected so that it does not engage the opening 701 of the coupling wing in a retracted condition of the corresponding bolt and the cover is free to be removed and separated from the supporting frame 30 of the locking mechanism. It is also free to be separated from the stationary frame 20 of the manhole.

In the embodiment shown, the openings 530 and thus the coupling wings 601 of the cover 1 are arranged in a radially retracted position with respect to the hooking wings 330 of the supporting frame 30.

The openings 701 in the coupling wings 601 coupling the cover to the supporting frame 30 of the locking mechanism are thus coinciding with the openings 430 on the hooking wings 330 and with the openings 42 on the bearing elements 40, when the latter openings 42 are provided.

FIG. 12 schematically shows the situation in a locking condition of the cover 1 to the supporting frame 30 and of the latter to the stationary frame 20 of the manhole.

The variant shown is the one in which the bearing elements 40 overlap the hooking wings 330 and have engagement openings 42 for engaging the bolt 4 that are coinciding with the openings 430 on said hooking wings 330.

As is clear, from FIG. 12 which explicitly shows only one transverse branch or only one radial branch 130 of the supporting frame 30 of the locking mechanism generally denoted by 1000, the coupling wing 601 of the cover 1 is engaged and passes through the coupling opening 530 provided in said branch 130 of the supporting frame 30. The opening 701, which is coinciding with the path of the bolt 4, is provided in the protruding part of this coupling wing 601. In the locking position shown, the bolt 4 passes through the opening 701 and constrains the cover to the supporting frame 30. The crosspiece 130 of the supporting frame 30 has a wing 330 at the end that abuts against a corresponding side element 120 of the frame 20, which wing is oriented towards the bottom and is inserted in the slit 50 delimited by the bearing element 40. The end of the crosspiece 130 leans on the upper edge of the wall forming the bearing element 40 and which simultaneously defines and delimits the slit 50.

The hooking wing 330 has an opening 430 which is coincident with an opening 42 in the wall of the bearing element 40 parallel to it and the two openings 430 and 42 are coinciding with one another and with the displacement path of the bolt 4. In the locking condition shown in FIG. 12, the end of the bolt 4 penetrates the opening 42 and 430, thus also locking the supporting frame 30 of the locking mechanism to the stationary frame 20 of the manhole.

As already previously mentioned, the present embodiment can be provided with any embodiment of the locking mechanism since it is independent of the specific embodiment thereof. A locking mechanism of the type described with reference to the preceding FIGS. 1 to 7, is shown in a non-limiting, but purely exemplary, way in FIG. 12

The invention claimed is:

1. A closing device comprising:
a frame configured to be stationary in a mounted condition of the closing device, the frame delimiting a through-slot;
a removable cover cooperating with said frame and configured to be alternatively arranged in a closing position of said through-slot and in an opening position of said through-slot, in a position not coinciding therewith,
said cover being provided with at least one locking mechanism for locking said cover to the frame in the closed position,
said locking mechanism having a plurality of bolts each oriented with at least one directional component respectively perpendicular to a peripheral edge of said cover, at least two bolts being oriented towards a different perimetric edge of the cover,
said bolts being arranged to be displaced from said locking mechanism between a retracted position with respect to said peripheral edge of the cover and a position protruding outwardly beyond said peripheral edge of the cover, engaging one stationary engagement seat provided in said frame with end lengths of said bolts protruding beyond said peripheral edge,
said locking mechanism being provided in combination with a drive tool of said locking mechanism;
drive enabling and disabling members of said mechanism,
wherein:
said locking mechanism comprises a motion drive rotor for a displacement of the bolts,
the motion drive rotor is mounted on the cover and is rotatable around an axis perpendicular to a plane subtended by the cover and/or by a plane containing at least one motion component of the bolts,
the motion drive rotor is integrally and rotationally coupled with a coupling joint part constituted by a coaxial projection having a non-round section cooperating with a corresponding joint part provided on a coupling end of the drive tool and constituted by a recess shaped and sized correspondingly to said projection,
the projection and/or the drive rotor are rotationally integral with a cylindrical cup provided on a lower side of the cover, the lower side being not visible in a closed condition of said through-slot, outside of said cylindrical cup;
at least one stationary anti-rotation locking wall of said cylindrical cup, said locking wall being constituted by at least one cylindrical shell wall segment that is coaxial to a shell wall of said cylindrical cup, the shell wall of said cylindrical cup and said locking wall each having at least one hole, said holes in said cylindrical cup and said locking wall being positioned to be coinciding between one another in a protruding position of said bolts; and
a radial locking screw or locking pin, which can be controlled manually or by a motorized drive in a position of simultaneous engagement of the holes in said cylindrical cup and said locking wall and in a position of disengagement from at least the hole provided in the locking wall, a head of said radial locking screw being provided with a head with a hollow having a shape that constitutes a key code or a control of the motorized drive that is configured to be actuated by a control enabling code.

2. The closing device according to claim 1, wherein enabling/disabling members are configured to be both are manually driven and servocontrolled enabling/disabling members so as to be actuated by control enabling codes.

3. The closing device according to claim 2, the servocontrolled enabling/disabling members comprise:
a motorized actuator that controls an actuation travel of the screw or a locking key with a transmission;
a power source of said actuator; and
a control unit for controlling an energy supply of the power source to said actuator, the control unit comprising a communication unit adapted to receive control signals of said control unit for interdiction or activation of the energy supply to the actuator.

4. The closing device according to claim 1, wherein sensors detecting an actuation travel performed are combined with the locking screw or pin, the actuator, and/or a transmission are connected to a communication unit adapted to transmit signals to a monitoring unit of an enabling/disabling status of the locking mechanism.

5. The closing device according to claim 1, further comprising an additional enabling/disabling member of manual type in combination with an enabling/disabling member of servocontrolled type.

6. The closing device according to claim 5, wherein two concentric cylindrical cups are rotationally coupled to the drive rotor of the bolts, said two cylindrical cups being rotatable separately between one another, a first cup of the two concentric cylindrical cups being rotationally integral with a joint part cooperating with a corresponding joint part provided on the drive tool of the locking mechanism, and a second cylindrical cup two concentric cylindrical cups being of greater diameter than the first cup and being supported to be freely rotatable, the first cup and the second cup being arranged one inside the other and being provided with two coaxial engagement holes of a screw or radial connection pin, which is removably engageable in said two coaxial engagement holes, the servocontrolled enabling/disabling members being constituted by a screw or pin that is disposed to be displaced between a position of engagement and a position of disengagement from a corresponding engagement hole provided in the second cylindrical cup.

7. The closing device according to claim 6, further comprising, in a different angular position with respect to an angular position of the servocontrolled enabling/disabling members and to the screw and pin of the two cylindrical and concentric cups, at least one additional manually driven enabling/disabling member that comprises a radial locking screw or locking pin that is controlled manually, a head of said radial locking screw being provided with a head with a hollow whose shape constitutes a key code,
wherein, in combination with at least one stationary anti-rotation locking wall of said cylindrical cup that is constituted by at least one cylindrical shell wall segment that is coaxial to a shell wall of said cylindrical cup, the shell wall of said cylindrical cup and said locking wall each having at least one hole to provide at least two holes, said two holes are positioned to be coinciding between one another in the protruding position of said bolts, and
wherein said locking screw or said locking pin are arranged to be manually displaced to a position of simultaneous engagement of the two holes and to a position of disengagement from at least the at least one hole provided in the locking wall.

8. The closing device according to claim 7, wherein the second cylindrical cup is further provided with a hole coinciding with the at least one in the locking wall and in which the manually driven locking screw or pin engages.

9. The closing device according to claim 7, further comprising two locking walls coaxial to one another and to the first and/or second cylindrical cup, said two locking walls being provided one inside and the other outside of a shell wall of the first cylindrical cup.

10. The closing device according to claim 1, wherein the motion drive rotor is constituted by a cogwheel, with which racks driving actuation travels of corresponding bolts mesh directly or by way of transmission gears, further comprising two bolts oriented towards edges opposite to one another and combined with the closing cover, the racks combined with the bolts being provided on diametrically opposite sides of the transmission gears.

11. A closing device comprising:
a frame configured to be stationary in a mounted condition of the closing device, the frame delimiting a through-slot; and
a removable cover cooperating with said frame and configured to be alternatively arranged in a closing position of said through-slot and in an opening position of said through-slot, in a position not coinciding therewith,
wherein said cover is provided with at least one locking mechanism for locking said cover to the frame in the closed position,
wherein said locking mechanism has a plurality of locking bolts for each perimetric edge of said cover, said locking bolts being arranged to be displaced alternatively by said locking mechanism between a retracted position with respect to said perimetric edge of the cover and a position protruding outwardly beyond said perimetric edge of the cover, engaging a stationary engagement seat provided in said frame with end length of said locking bolts protruding beyond said perimetric edge, and
wherein said locking bolts are constituted by levers swinging in a plane parallel to a plane subtended by the frame and/or the cover and around axes perpendicular to said plane, wings being displaceable to an angular position, in which said wings do not protrude beyond the perimetrical edge of the cover, and to a position in which said wings protrude beyond said perimetric edge of the cover, each of the locking bolts engaging a corresponding engagement seat integral with the frame.

12. The closing device according to claim 11, wherein said wings are each controlled independently of other wings by a dedicated locking mechanism by way of a drive tool of said locking mechanism.

13. The closing device according to claim 11, wherein said locking mechanism is common to at least a part of said levers or all of said levers, whereby by actuating said locking mechanism, at least said part of said levers or all of the levers are driven simultaneously in order to assume a position not protruding from a corresponding perimetric edge of the cover or a position of engagement in a corresponding engagement seat on the frame.

14. The closing device according to claim 12, wherein the locking mechanism is driven by servocontrolled means comprising a motorized actuator that controls an actuation travel of the lever or levers with a transmission provided for each locking mechanism;
further comprising:
a power source of said motorized actuator; and
a control unit to control an energy supply of the power source to said motorized actuator, said control unit comprising a communication unit adapted to receive control signals of said control unit for an interdiction or activation of the energy supply to the motorized actuator or by manual drive, coupling joints between the drive tool and the locking mechanism being constituted by a non-round shaped hollow whose shape encodes a key code.

15. The closing device according to claim 11, the locking mechanism is provided in combination with enabling and disabling members to enable/disable a displacement travel of said levers and/or a drive of said locking mechanism, which can be of manual or servocontrolled type.

16. A closing device comprising
a frame configured to be stationary in a mounted condition of the closing device, the frame delimiting a through-slot;
a removable cover cooperating with said stationary frame and configured to be alternatively arranged in a closing position of said through-slot and in an opening position of said through-slot, in a position not coinciding therewith,
said cover being provided with at least one locking mechanism for locking said cover to the frame in the closed position,
said locking mechanism having a plurality of bolts each oriented with at least one directional component respectively perpendicular to a peripheral edge of said cover, at least two bolts being oriented towards a different perimetric edge of the cover,
said bolts being arranged to be displaced from said locking mechanism between a retracted position with respect to said peripheral edge of the cover and a position protruding outwardly beyond said peripheral edge of the cover, engaging one stationary engagement seat provided in said stationary frame with their end lengths protruding beyond said peripheral edge,
said locking mechanism being provided in combination with a drive tool of said locking mechanism, drive enabling and disabling members of said locking mechanism being further provided,
wherein said locking mechanism is mounted on a supporting frame separated from the cover and removably fixable to the stationary frame delimiting a passage opening, said supporting frame of the locking mechanism being provided with at least two hooking appendages each on one of two opposite sides of said supporting frame, the hooking appendages being hooked to hooking seats carried by the stationary frame, on an inner side thereof,
the cover being further provided with at least two removable coupling appendages for coupling to said supporting frame, the coupling appendages cooperating with the engagement seats provided on the supporting frame when the supporting frame and the cover are in a coupled position between one another and a frame of a manhole,
wherein the hooking appendages of the supporting frame of the locking mechanism and the coupling appendages of the cover are provided with second engagement seats which, in a coupled position between one another and the stationary frame of the manhole, become positioned in a position coinciding with a path of a corresponding bolt.
wherein, when in a position of the bolts displaced outwardly towards the stationary frame, at least two bolts simultaneously engage a corresponding hooking seat combined with the stationary frame of the manhole, a corresponding engagement seat provided in the hooking appendages of the supporting frame and a corresponding engagement seat provided in the coupling appendages of the cover to the supporting frame, lock the cover to the supporting frame and further lock the supporting frame of the locking mechanism to the stationary frame of the manhole, and
wherein, in a retracted condition of the bolts, the bolts no longer engage said engagement seats and the cover can be freely separated from the supporting frame of the locking mechanism, and the supporting frame of the locking mechanism can be freely separated from the stationary frame of the manhole.

17. The closing device according to claim 16,
wherein the supporting frame of the locking mechanism is constituted by at least one crosspiece having a length substantially corresponding to a distance of two opposite sides of the stationary frame of the manhole and that, on each end thereof, has a wing perpendicular to a longitudinal extent of the crosspiece to provide two opposite wings and/or to a travel direction of the bolts and parallel to a plane oriented in direction of an axis of an opening delimited by said stationary frame and/or optionally to a side thereof combined with a corresponding end of the crosspiece,
wherein the stationary frame has, in a position aligned with each of said two opposite wings, a support element of a corresponding end of the crosspiece, the support element being fixed on a side of each side element of the stationary frame of the manhole combined with an end of said crosspiece and having or delimiting a hooking slit of a corresponding hooking wing, each hooking wing having a length so that, when the supporting frame of the locking mechanism is in a hooked condition to the stationary frame of the manhole, an end length thereof protrudes beyond a lower end of a corresponding hooking slit,
wherein in said protruding end length each hooking wing has an engagement opening that is adjacent to the lower end of the corresponding hooking slit and that is coinciding with a displacement path of the corresponding bolt,
wherein, in a position of the bolt pushed towards the stationary frame of the manhole, the bolt passes through said engagement opening and becomes positioned directly under the lower end of the hooking slit, becoming superimposed to the lower edge of the support element delimiting the hooking slit, and
wherein, in the retracted condition of the bolts, each bolt is fully extracted from the opening provided in the corresponding hooking wing of the supporting frame of the locking mechanism.

18. The closing device according to claim 17,
wherein the support elements have a wall parallel to the corresponding hooking wing, an opening for passage of the corresponding bolt, which is positioned coincidently with the engagement opening of said bolt and is provided on the hooking wing of the supporting frame, being provided in said wall, and
wherein, when the bolt is pushed outwardly in the locking position, said bolt passes through the engagement opening in the hooking wing of the supporting frame of the locking mechanism and in the opening provided in the wall of the support element.

19. The closing device according to claim 18,
wherein the cover has at least two coupling appendages for coupling to the supporting frame of the locking mechanism, the two coupling appendages being shaped as wings oriented the hooking wings of the supporting frame and protruding from the lower side of the cover towards the supporting frame of the locking mechanism,
further comprising coupling wings in a position coinciding with the engagement loops provided in the crosspiece forming the supporting frame, said coupling wings having a length so that, in a coupled position of the cover to the supporting frame, the coupling wings protrude from the lower side of the supporting frame with an end length,
wherein in said end length each coupling wing has an engagement slot of the corresponding bolt, said slot coinciding and being aligned with a travel of said bolt with the engagement opening in the corresponding hooking wing of the supporting frame to the frame of the manhole.

20. The closing device according to claim 16, wherein the plurality of bolts are four bolts arranged cross-wise to one another, wherein the supporting frame is obtained with a cross-shaped plan shape correspondingly to orientations of displacement paths of the bolts, each branch of the supporting frame of the locking mechanism being provided at a free end with a hooking wing cooperating with a corresponding hooking seat or slit on the stationary frame of the manhole.

21. (canceled)
